(19) United States
(12) Patent Application Publication
(10) Pub. No.: US 2014/0270127 A1
(43) Pub. Date: Sep. 18, 2014

(54) SHARED LOCK CONTROL

(71) Applicant: Avaya Inc., Basking Ridge, NJ (US)

(72) Inventor: Gary Becker, Thornton, CO (US)

(73) Assignee: AVAYA INC., Basking Ridge, NJ (US)

(21) Appl. No.: 13/833,772

(22) Filed: Mar. 15, 2013

(51) Int. Cl. H04M 1/67

(52) U.S. Cl. CPC H04M 1/67
USPC 379/194

(57) ABSTRACT

The present disclosure is directed to methods and systems for setting a lock state for a second device in a system, where the system includes a server, a first device in communication with the server, and the second device in communication with the server, the method including: (a) a user setting a lock state for the first device; and (b) the system setting a lock state for the second device in response to the user setting the lock state for the first device.

### FIELD

The disclosure relates generally to methods and systems of locking devices and particularly to methods and systems for users to lock and/or unlock multiple devices substantially simultaneously.

### BACKGROUND

At the present time, users typically have multiple electronic devices that require locking and unlocking. For example, users employ multiple devices simultaneously, such as a personal computer (PC), a tablet, a laptop, a television, a smart phone, a personal digital assistant (PDA), and/or a phone. The phone may be embodied as a mobile device, cellular phone, cordless phone, desk phone, hard phone, or soft phone. It can be time consuming, inconvenient, and inefficient for a user to lock or unlock more than one device, especially when multiple devices are required to complete a task or series of tasks.

### SUMMARY

Methods exist for shared control of devices; however, these methods are limited. For example, methods for monitoring the desktop display include taking a “screen shot” of the desktop display (e.g., creating a Joint Photographic Experts Group (PEG) file that represents the desktop display). Such methods are problematic because they are resource heavy (because they have to capture the entire desktop display), they may not be interactive, and they may not be executed in true real-time.

In addition, a supervisor computer may directly communicate, via User Datagram Protocol (UDP) packets, with call control software in a softphone. The UDP packets can provide real-time status information, from the soft-phone to the supervisor computer, describing call activity and usage status of the softphone. The supervisor computer is able to remotely control usage of the softphone according to information provided by the UDP packets.

However, improved methods and systems are needed to assist a user in locking and/or unlocking more than one device automatically and/or at a substantially similar time (e.g., a computationally simultaneous or near simultaneous time). Such methods and systems may advantageously improve the security of devices and/or systems, save tine, and reduce inconvenience, among other advantages.

In particular, for certain aspects, whenever a deskphone and a softphone are in shared control, each is sending call progress status to the other one. In addition to sending that call progress status, they could be made to send lock/unlock status to each other as well. For example, when the computing device's screen blanker timer expires and the computing device locks itself, the softphone would detect that fact and send a message to the deskphone: lock yourself. When the user returns to his desk and unlocks the deskphone, the deskphone would send a message to the softphone: unlock the computing device.

For example, when a user locks or unlocks a softphone, the softphone would query the computing device's screen blanker locked state, then send that information to the deskphone. The deskphone station locks itself, or unlocks itself, accordingly. The same thing works in the opposite direction. If the deskphone is locked, and the user dials the unlock code through the deskphone, the shared control softphone unlocks the computing device's screen blanker.

This may also be a user-configurable feature. Some users wouldn't want the telephone to unlock the computing device every time, for security reasons. Also, telephone unlock codes tend to be shorter than computing device unlock codes, and some users wouldn't want their telephone locked via timeout. Certain companies (e.g., big financial institutions) who want the computing device and the deskphone to both be registered and unregistered together instead of locked and unlocked may not use or may disable this feature.

Note that, in some embodiments, this is only for fixed devices like a desktop shared control softphone and desktop phone. If a user has multiple devices (e.g., a WiFi phone and a desktop computing device) or a desktop phone and a portable laptop computing device, they may not want the mobile phone to suddenly station-lock when they walk away from the desk. Or worse yet, they may not want the desktop computing device to unlock when they place a call from their mobile phone. Shared control may guarantee the two devices are adjacent to each other and used concurrently. For example, Bluetooth could be used to coordinate the lock state only if the two devices are in close proximity to each other. Further, if a user is standing outside their office and they receive a phone call and then rush away to a meeting, the user may not want their computing device to be unlocked for the next 20 minutes, until the screen blanker kicks in again. Thus, the algorithm could include instructions to, for example, “lock whenever out of Bluetooth range.” These and other needs are addressed by the various embodiments and configurations of the present disclosure.

The following presents a simplified summary of the disclosure to provide an understanding of some aspects of the disclosure. This summary is not an extensive overview of the disclosure and its various embodiments. It is intended neither to identify key or critical elements of the disclosure nor to delineate the scope of the disclosure but to present selected concepts of the disclosure in a simplified form as an introduction to the more detailed description presented below.

The present disclosure(s) is directed generally to methods for setting a lock state (e.g., locking and/or unlocking) multiple devices. For example, the present disclosure is directed generally to systems including a server; a first device in communication with the server, where a user is logged in to the first device; a second device in communication with the server, where the user is logged in to the second device; where the user logs out on the first device and is automatically logged out on the second device, or vice versa. Further, the present disclosure is directed generally to systems including a server; a first device in communication with the server, where a user logs in to the first device; and a second device in communication with the server, where the user logs in on the first device and is automatically logged in on the second device, or vice versa.

In certain aspects, the present disclosure relates to methods for locking a second device in a system, where the system includes a server, a first device in communication with the server, and the second device in communication with the server, the method including: (a) a user locking the first device; and (b) the system locking the second device in response to the user locking the first device.

In further aspects, the present disclosure relates to methods for unlocking a second device in a system, where the system includes a server, a first device in communication with the server, and the second device in communication with the server, the method including: (a) a user unlocking the first device; and (b) the system unlocking the second device in response to the user unlocking the first device.

In still further aspects, the present disclosure relates to systems, including: a server; a first device in communication with the server; and a second device in communication with the server; where a user locks the first device, and where the system automatically and without any further input from the user locks the second device in response to the user locking the first device.

In still further aspects, the present disclosure relates to systems, including: a server; a first device in communication with the server; and a second device in communication with the server; where a user unlocks the first device, and where the system automatically and without any further input from the user unlocks the second device in response to the user unlocking the first device.

Methods and systems disclosed herein advantageously allow a user to automatically log into or out of multiple devices and/or applications based on logging into or out of a device and/or application. Further, methods and systems disclosed herein advantageously allow a user to automatically register on devices that include virtual environments. Still further, methods and systems disclosed herein advantageously allow a user to automatically register on devices where the user is using native audio/video components associated with one of the devices on which they wish to automatically register. These and other advantages will be apparent from the disclosure of the disclosure(s) contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic even if performance of the process or operation uses human input, whether material or immaterial, received before performance of the process or operation. Human input is deemed to be material if such input influences how the process or operation will be performed. Human input that consents to the performance of the process or operation is not deemed to be “material”.

The terms “determine”, “calculate” and “compute,” and variations thereof, as used herein, are used interchangeably and include any type of methodology, process, mathematical operation or technique.

The term “computer-readable medium” as used herein refers to any tangible storage and/or transmission medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

The term “social network” means a grouping of people having a common characteristic, such as having common interests, passions, beliefs, experiences, and/or needs. The characteristic may be positive or negative. For example, pro-republican persons are members of a pro-republican party social network infrastructure while anti-republication persons are members of an anti-republican social network. In one configuration, at least most of the social network structure members do not know one another personally, are not employed by a common business entity, and are also members of the general public. In another configuration, the social network is a social structure made of nodes which are generally individuals or organizations. It indicates the ways in which they are connected through various social familiarities ranging from casual acquaintance to close familial bonds.

As used herein, the terms “locking” and “unlocking” refer to gaining or preventing logical and/or physical access to one or more devices, for example using a password, passcode, predetermined gesture input, predetermined motion, keyword, keyphrase, action, series of actions, or some other type of user authentication action to prove the identity of a user, to prove something the user knows and/or possesses, and/or to prevent unauthorized access.

The above-described embodiments and configurations are neither complete nor exhaustive. As will be appreciated, other embodiments of the disclosure are possible utilizing, alone or in combination, one or more of the features set forth above or described in detail below.

### BRIEF DESCRIPTION OF THE DRAWINGS

FIG. 1 is a block diagram of a system in accordance with embodiments of the present disclosure;

FIG. 2 is a block diagram of a system in accordance with embodiments of the present disclosure;

FIG. 3 is a flowchart illustrating aspects of the operation of a system in accordance with embodiments of the present disclosure; and

FIG. 4 is a flowchart illustrating aspects of the operation of a system in accordance with embodiments of the present disclosure.

### DETAILED DESCRIPTION

FIG. 1 depicts a system 100 in accordance with embodiments of the present disclosure. The system 100 includes a user 105 having multiple devices; for example device 104 and device 106, where device 104 and device 106 are connected to a communication network 110. Devices 104 and/or 106 can be any communication device that can communicate on or with network 110. The term “device,” as used herein, may also refer to applications on a device, such as enterprise software, accounting software, office suites, media players, etc. There may be multiple applications on any one device, and each device and/or application may require user registration, as described herein. Devices, for example, can be and are not limited to a computing device, including a telephone, a Personal Digital Assistant (PDA), a server, a router, a Personal Computer (PC), a lap-top computer, a tablet device, a Private Branch Exchange (PBX), and/or a communication system. For example, devices may include endpoints that are softphones running in various native operating systems or using a virtual environment hosted in a data center. Although only two devices 104, 106 and one user 105, are shown in FIG. 1, the exemplary system 100 may comprise any number of communication devices and users.

Network 110 can be any network that can send and receive information, such as the Internet, a Wide Area Network (WAN), a Local Area Network (LAN), the Public Switched Telephone Network (PSTN), a packet switched network, a circuit switched network, a cellular network, a combination of these, and the like. Network 110 can use a variety of protocols, such as Ethernet, Internet Protocol (IP), Session Initiation Protocol (SIP), Integrated Services Digital Network (ISDN), Voice over IP (VoIP) network, and the like. Network 110 can include any number of communication devices, as well as various types and quantities of servers, gateways, network border devices, etc.

Devices as disclosed herein may include a processor, software, and user input, among other components. Devices can also be a Virtual Desktop Infrastructure (VDI) client device, an application (e.g., an application in a native or virtual environment, a softphone operating in a virtual environment, a softphone operating in native environment, or each of a softphone operating in a virtual environment and a native environment hosted in a data center), a browser, or the like. Processors associated with devices disclosed herein can be any processor that can process software such as a microprocessor, a Digital Signaling Processor (DSP), a multi-core processor, a computer, and/or the like.

Software associated with devices disclosed herein can be any machine-readable instruction or set of instructions that can be downloaded onto (e.g., stored in) memory of a communication device. For example, software can include software to upgrade an operating system, software to patch an operating system, a software application, a configuration file, a user profile, a document, a spreadsheet, and/or the like. Software can also include an application that may be virtually hosted and rendered on a device.

User input associated with devices disclosed herein can be a data structure and can be stored in memory with software or as part of the software. Furthermore, the data structure may be persistent or dynamic in its existence on device and may be automatically provisioned, user provisioned, or administrator provisioned. User input can include user registration information, including, for example, user identification and/or user password or gesture.

In embodiments, devices disclosed herein may be VDI client devices, as described above. In addition, the network may include a VDI server with channels passing data between the VDI devices and the VDI server. The data may be data that is generated and/or exchanged in connection with the provision of a hosted virtual computing device service provided to a VDI client device by the VDI server. Further, VDI client devices may include a VDI communication application. As an example, but without limitation, a VDI communication application can include a softphone function, to support communications with other VDI client devices and/or other communication devices. A VDI device may also include a virtual machine. Illustrative VDI devices are described in U.S. Patent Publication No. 2011/0208908, which is fully incorporated herein by reference. Accordingly, the VDI communication application can function as an endpoint for a telephony session implemented using the SIP or other real-time transport protocol (RTP) protocol, including, but not limited to, the secure real-time transport protocol (SRTP). More particularly, the VDI communication application can support direct RTP communications between a VDI client device and a communication endpoint. Accordingly, a RTP communication channel between VDI client devices may be received at the respective VDI communication applications of the VDI client devices.

FIG. 2 depicts a system 200 in accordance with embodiments of the present disclosure. The system 200 includes a user 205 having multiple devices; for example deskphone 204 and computing device 206, where deskphone 204 and computing device 206 are connected to a communication network 210 and located at a desk 202. Computing device 206 has a softphone 208. Also, user 205 has a portable computing device (e.g., a tablet) 220 with a softphone 222, where the tablet 220 is connected to the communication network 210.

Deskphone 204, computing device 206, tablet 220, and softphones 208, 222 are associated with user 205. In embodiments, user 205 may lock deskphone 204 and softphones 208, 222. In various embodiments, locking/unlocking a device is different than logging out/in to a device. For example, when a user desires to use a locked device, the locked device may only require the user to enter a password. In contrast, a logged-out device may require a user to enter both an identification (e.g., a phone number or user name) and a password. In addition, a locked phone can still be subject to maintenance checks from a call server, and it can still shows up on the call server's system reports. In contrast, a logged-out phone isn't associated with any call server (e.g., it gets no maintenance testing and doesn't show up in any reports). Further, depending on the system, there can be other differences as well, such as whether they allow emergency calls.

Also, the devices shown and described in FIG. 2 may be paired using shared control. For example, the system 200 may include a computer and/or a supervisor computer 240, and using elements of such a system (e.g., a phone network interface), some or all of the system 200 may be utilized by a calling device (e.g., a land-line telephone, a cellular phone, a “smart” phone, among others) as well as a softphone system. A first connection may be established between the softphone 208 and/or softphone 222 and the supervisor computer 240, and a second connection may also be established between the softphone 208 and/or softphone 222 and a caller (e.g., user 205). Connections may use the call control application software provided in the softphone application associated with softphone 208 and/or softphone 222. Thus, the call control application not only may be used to establish the voice connection between the caller and softphone 208 and/or 222, hut the call control application may also populate the softphone's desktop with information about the voice call (e.g., length of time of the call, time, and date, among others), including information (e.g., using a lookup table that matches personal and/or marketing information about the caller based on the caller's phone number, etc.) about the caller making the voice call as well as equipment used by the caller (e.g., phone number identification, etc.). Various types of phone signaling (such as H323 or SIP, among others) may be used to set up shared control. In various embodiments of the disclosure, any devices involved in a communication may understand another device's signal that the device is locked or unlocked.

For example, UDP data packets (e.g., XML-extended) may then be communicated back and forth between the call control application and the supervisor computer 240. This information permits the supervisor computer 240 to control the softphone 208 and/or 222 without being restricted to a particular type of soft phone or software, since such communication is performed by a specially-coded application programming interface (API) at the supervisor computer 240. Thus, the API at the supervisor computer 240 may thereby provide an interface that does not care what software is running on the softphone 208 and/or softphone 222.

Further, embodiments of the present disclosure may be implemented using a Linux system, for example the X Window System. The X Window System allows an external “screensaver” client to detect when the alternate image is to be displayed. For example, softphone 208 may have an associated softphone application that reads whether the variable “state” in the software library X11/extensions/scrnsaver.h is currently set to “off” or “on” if the application wants to know whether the deskphone 204 is locked or unlocked. If the softphone 208 wants to change whether deskphone 204 is locked or unlocked (e.g., change the lock state), it sets the variable “state” to be “on” or “off,” respectively.

In additional illustrative embodiments, the devices may share their states using shared control; for example, the devices may register at a central call server with a registration message that contains the user's phone number (which may be the same for multiple devices). Further, a device may register directly to another device, without going through a central call server. The registration message may include a component that allows the device to convey that it is registering in a shared control mode (e.g., a proprietary message or code). Still further, the devices may run on a specified schedule to share their state, or the software doing the locking and unlocking may send a message to the other device whenever the lock/unlock state changes (for example, a Linux query may allow ScreenSaverNotify events to be generated whenever the screen saver is activated or deactivated, and Linux may also allow the event API to provide a mechanism to execute a function when a specific event occurs, which may send a message to a device, or to various programs running in a device.

Thus, in additional illustrative embodiments, a user may lock a desk device using the desk device's lock command (such as by typing a particular code a deskphone's keypad and/or a mobile device's keypad), and a device (e.g., softphone 208) may run the Linux command gnome-screensaver-command-q to determine whether a device (e.g. deskphone 204) is locked or unlocked. If the softphone 208 wants to lock the deskphone 204, it may run the Linux command gnome-screensaver-command-l, and if the softphone 208 wants to unlock the deskphone 204, it may run the Linux command gnome-screensaver-command-d.

The illustrative flow shown in FIG. 3 will now be described with respect to the system components shown in FIG. 2. FIG. 3 shows an illustrative flowchart illustrating aspects of the operation of a system in accordance with embodiments of the present disclosure.

In step 300, the process starts and proceeds to step 302 where a user (e.g., user 205) locks a first device (e.g., deskphone 204). In step 304, the system determines that the user locked the first device. Such a determination may be done using the methods and systems disclosed herein. In step 308, the system determines if there are associated devices (could be user-administered, detection of other operational devices via a common network, detection via Bluetooth, and detection via RF communication, among others) which should be locked based on the user locking the deskphone 204. If the system detects another device (e.g., softphone 208 and/or PC 206), the process proceeds to step 310, where the system locks the other device. If the system does not detect another device, the process proceeds to step 314, where it ends.

In step 312, the system determines if there are additional devices (could be user-administered, detection of other operational devices via a common network, detection via Bluetooth, detection via RF communication, etc.) that should be locked based on the user locking the deskphone 204. If the system detects an additional device, the process proceeds to step 310, where the system locks the other device. For example, if the system locked deskphone 204 based on the user locking PC 206, the system may determine that softphone 222 and/or tablet 220 are currently unlocked, and may lock the device(s). If the system does not detect another device, the process proceeds to step 314, where it ends.

The illustrative flow shown in FIG. 4 will now be described with respect to the system components shown in FIG. 2. FIG. 4 shows an illustrative flowchart illustrating aspects of the operation of a system in accordance with embodiments of the present disclosure.

In step 400, the process starts and proceeds to step 402 where a user (e.g., user 205) unlocks a first device (e.g., deskphone 204). In step 404, the system determines that the user unlocked the first device. Such a determination may be done using the methods and systems disclosed herein. In step 408, the system determines if there are associated devices (could be same determination as with FIG. 3) which should be unlocked based on the user unlocking the deskphone 204. If the system detects another device, the process proceeds to step 410, where the system unlocks the other device. If the system does not detect another device, the process proceeds to step 414, where it ends.

In step 412, the system determines if there are additional devices which should be unlocked based on the user unlocking the deskphone 204. If the system detects an additional device, the process proceeds to step 410, where the system logs the user out of the other device. If the system does not detect another device, the process proceeds to step 414, where it ends.

The exemplary systems and methods of this disclosure are described in relation to a distributed processing network. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show certain of the various components of the system as being collocated, certain components of the system can be located remotely, at distant portions of a distributed network, such as a LAN and/or the Internet, or within a dedicated system. Thus, it should be appreciated, that the components of the system can be combined in to one or more devices, such as a communication device rather than a server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of other variations and modifications of the disclosure can be used. It would be possible to provide for some features of the disclosure without providing others.

For example in one alternative embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, includes components, methods, processes, systems and/or apparatus substantially as depicted and described herein, including various embodiments, subcombinations, and subsets thereof. Those of skill in the art will understand how to make and use the present disclosure after understanding the present disclosure. The present disclosure, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. The features of the embodiments of the disclosure may be combined in alternate embodiments other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the description of the disclosure has included description of one or more embodiments and certain variations and modifications, other variations, combinations, and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for securing a second device in a system, wherein the system comprises a server, a first device in communication with the server, and the second device in communication with the server, the method comprising:
(a) a user setting a shared lock state for the first device; and
(b) the system automatically setting a shared lock state for the second device in response to the user setting the shared lock state for the first device.

2. The method of claim 1, wherein the shared lock state for the first device and the shared lock state of the second device are both one of locked or unlocked.

3. The method of claim 1, wherein at least one of the first device and the second device is running a softphone.

4. The method of claim 2, wherein at least one of the first device and the second device is running a softphone.

5. The method of claim 1, wherein at least one of the first device and the second device is running a softphone, and wherein the other of the first device and the second device is not running a softphone.

6. The method of claim 2, wherein at least one of the first device and the second device is running a softphone, and wherein the other of the first device and the second device is not running a softphone.

7. The method of claim 1, wherein the first device is a deskphone and the second device is a softphone.

8. The method of claim 2, wherein the first device is a deskphone and the second device is a softphone.

9. The method of claim 1, wherein the first device and the second device are paired using shared control.

10. The method of claim 2, wherein the first device and the second device are paired using shared control.

11. A non-transitory computer readable medium comprising processor executable instructions to perform the steps of claim 1.

12. A system for securing a second device, comprising:
a server;
a first device in communication with the server; and
the second device in communication with the server;
wherein a user sets a lock state for the first device, and wherein the system sets a lock state for the second device in response to the user setting the lock state for the first device.

13. The method of claim 1, wherein the shared lock state for the first device and the shared lock state of eh second device are both one of locked or unlocked.

14. The system of claim 12, wherein at least one of the first device and the second device is running a softphone.

15. The system of claim 13, wherein at least one of the first device and the second device is running a softphone.

16. The system of claim 12, wherein at least one of the first device and the second device is running a softphone, and wherein the other of the first device and the second device is not running a softphone.

17. The system of claim 13, wherein at least one of the first device and the second device is running a softphone, and wherein the other of the first device and the second device is not running a softphone.

18. The system of claim 12, wherein the first device is a deskphone and the second device is a softphone.

19. The system of claim 13, wherein the first device is a deskphone and the second device is a softphone.

20. The system of claim 12, wherein the first device and the second device are paired using shared control.
